(19) United States
(12) Patent Application Publication
(10) Pub. No.: US 2016/0235024 A1
(43) Pub. Date: Aug. 18, 2016

(54) Flexible hydroponics growing model and system

(71) Applicant: Xiamen SUPERPRO Technology CO., Ltd., Xiamen (CN)

(72) Inventors: Liqiang XU, Xiamen (CN); Mingshan HUANG, Xiamen (CN)

(73) Assignee: Xiamen SUPERPRO Technology CO., Ltd., Xiamen (CN)

(21) Appl. No.: 14/621,401

(22) Filed: Feb. 13, 2015

(51) Int. Cl. A01G 31/02

(52) U.S. Cl. CPC A01G 31/02

(57) ABSTRACT

The invention introduces a flexible growth model of hydroponics including frame, growing modules and growing medium. The frame acts as a skeleton to provide support for the whole growing modules. The growing module is made of flexible materials to hold the hydroponics growing medium. The invention also provides a model of flexible hydroponic system, through which store less water (through the way of storing less water in each individual flexible growing modules). It effectively reduces the needed water pumped to the plants. The system can connect up to 48 growing modules, by using this system, users can save the needed water and nutrients ½ less than the present flood and drain system.

### FIELD OF THE INVENTION

The present invention relates to a flexible hydroponics growing module and system, according to the international patent classification (IPC) division, it belongs to the plant hydroponics system technology field, especially those involving a plant hydroponics with flexible growth model and the cycle system of “flood—drain”.

### BACKGROUND OF THE INVENTION

Hydroponics is basically the science of growing plants without using ordinary organic soil. Hydroponics works better than soil because of the plants need for oxygen within the root zone. In most soils, there is not much space for oxygen to exist and it is difficult to get fresh oxygen into the root zone, to many plant species, that limits the growth rate and final product that the plant is producing. Hydroponics solves that problem by using a replacement for the soil.

The replacement for the soil is referred to generally as growing medium or soilless growing mediums. They can consist of both naturally occurring materials such as coco fiber (husks from coconut shells), rock wool (blown silica) or also from man-made materials such as clay balls, closed cell polystyrene or foam. All of these growing mediums tend to hold more oxygen because of greater spacing and lower density than natural soil can have. When comparing a soil grown plant with a hydroponically grown plant, hydroponic plants will grow faster, larger and produce more fruit or product nearly 100% of the time. For this reason more people are choosing to use hydroponics instead of pure soil for increased plant production.

There are approximately 100 of different hydroponics systems on the market, but all of them can be divided into just 4 groups.

1, Recirculating; 2, Run-to-waste; 3, Deep water culture; 4, Aeroponics.

Within each hydroponic system group are many various methods to apply each technique. Our flexible grow module design can be used with all of the methods except for Aeroponics, but is best suited to be used as a recirculating system. In a recirculating hydroponic system, the water is pumped from a storage tank out to the plants, and then recovered (re-circulated) back to the water storage tank. Our design will be best suited to be used as a flood-and-drain recirculating system.

Flood and drain systems normally flood (fill) the growing containers with nutrient rich water and then drain the water back out of the growing containers back to the water storage tank. In the process of this repeating flood and drain cycle, water will wet the growing medium as well as to displace stale air from around the roots. When the water is drained from the growing modules, fresh air/oxygen will be drawn back into the rooted areas providing fresh oxygen for the plants roots. This method provides the optimum supply of nutrients and oxygen to the plants while also controlling the pH of the rooting zone by providing pH balanced nutrients frequently to the plants. For large hydroponic systems, flood and drain is difficult because of the large amount of water required, here is why.

In a flood and drain system, the plants are normally placed on top of a large flood tray which can be up to 5-6 inches deep and have a capacity of many gallons. The entire flood tray is then filled with water. This process normally requires a large amount of water to be stored and pumped in and out to the plants. It also exposes the water and rooting area to potential pests, algae growth and other damaging effects. There are many shapes and sizes of rigid hydroponics growing modules (grow pots/container) which are normally injected of thermoplastic material. An example of a rigid injection hydroponic module 101 which is shown in FIG. 1. All of those rigid growing module normally bulky, heavy, expensive and hard to delivery due to the large physical size. Our design get away the rigid/solid sides of the growing module instead we use a kind of water-tight (impermeable) cloth which is flexible and will hold the water equally as with a rigid-solid grow module/container.

All of the current designs are merely flexible “soil bags” which can be filled with soil or other growing medium and watered from the top like a regular plant would be watered. An example of a common growing bag diagram 102 which is shown in FIG. 2. Our product is designed to be connected at the bottom of the grow module to a hydroponic controller that will accurately and repeatedly flood (fill) and drain the grow modules. None of the current similar flexible soil bags can be used in this way.

### SUMMARY OF THE INVENTION

Aiming at the shortcomings of the existing technology, this invention provides a flexible hydroponics growing system. The design of the system can reduce the growing cost and only use the lightweight and foldable flexible material to hold the root growing medium of the plant, supported by foldable skeleton model, It avoids the rigidity of solid edge. The capacity of storing water is equal to the rigid growing module/container.

To achieve the above purpose, this invention is completed through the following technical scheme:

A flexible hydroponics growing system includes the frame, growing modules and the growing medium:

Skeleton, which is the supporting framework for the whole growing module;

Growing module is made of flexible material supported by skeleton, which can be filled with water as container to hold the growing medium. The water will be pumped in or out the growing medium through the outlet located in the bottom of growing module, the growing module inside will hold the growing medium;

The skeleton can be folded or unfolded, the growing module is formed when the skeleton is unfolded and connects with the growing module made of flexible material when the skeleton separates from the growing module made of flexible material and folds the skeleton, the size of growing module will be reduced significantly.

Another purpose of this invention is to provide a model of flexible hydroponic system, by using this flexible system, the water and nutrition storage can be greatly reduced to half than flood-drain system.

The complete flexible hydroponics system include: a central distribution module, a plurality of flexible hydroponics growing models, the flexible hydroponics growing models are connected to a central distribution module by a plurality of pipelines. Nutrient-rich water is stored in the main water storage container and transferred back and forth to the central distribution module, using a pair of submersible pumps. The flood pump is located inside the main water storage container and the drain pump is located inside of the central distribution container. The two pumps outlets are connected together with another piece of 20 mm pipeline. The submersible pumps are controlled using a pair of float switches located at the top and the bottom levels inside the central distribution container, The float switches communicate with a central controller that will automatically pump the nutrient water out to the central distribution container where gravity will equally distribute the water to all of the grow modules filling them. When all of the grow modules have been filled with water, the drain pump will be activated to drain all of the water back out of the flexible hydroponics growing models and the central distribution container by pumping the water back into the main water storage container. The controller will repeat the fill and drain process repeatedly based on time settings selected by the user.

The supporting frameworks outside the model containers (flexible) is foldable skeleton which can be made of plastic or rigid aluminum tube or pillars, it will support the plants and the growing medium, and make the individual growing module located above the ground in certain height. When folding support leg/shore open, the structure of the flexible growing module will be same stable as the rigid solid growing module; when folding back the skeleton, it will be folded into a bundle, the growing module of the flexible material container also can be compressed, it is convenient to store and save lots of space. This invention can be assembled as the complete hydroponics system that can automatically flood—drain nutrient solution for the roots of plant to provide fresh oxygen and nutrients in a timely manner and manage scientifically.

### BRIEF DESCRIPTION OF THE DRAWINGS

FIG. 1 is a rigid injection hydroponic module 101.

FIG. 2 is a common growing bag diagram 102.

FIG. 3 is the invention of the flexible growing containers module.

FIG. 4 is exploded view of FIG. 3.

FIG. 5 is the growing module section of this invention.

FIG. 6 is diagram of folding open frame.

FIG. 7 is diagram folding close frame.

FIG. 8 is diagram of a rotary joint part.

FIG. 9 shows the complete hydroponics system in this invention.

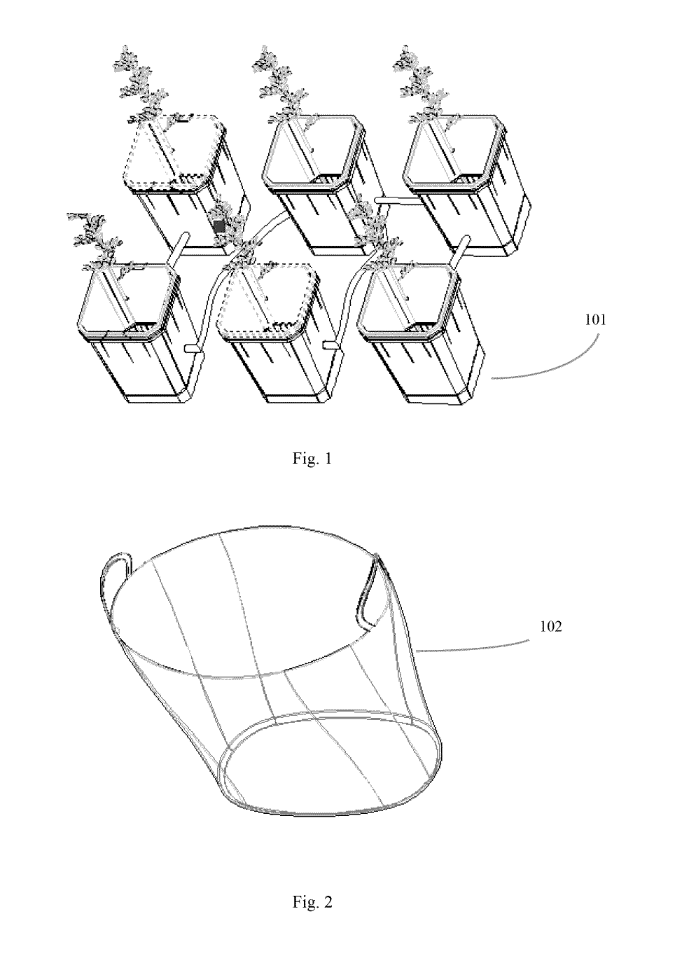

### DETAILED DESCRIPTION OF THE INVENTION

Below is the detail instruction combined with the appended drawing.

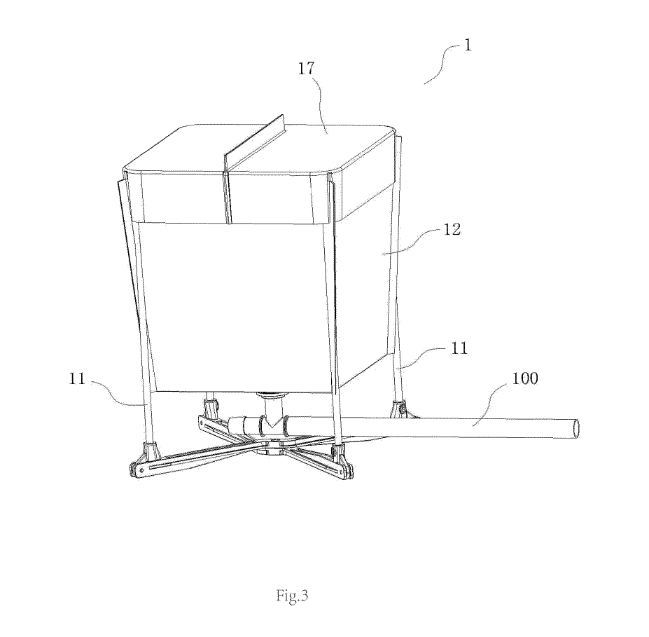

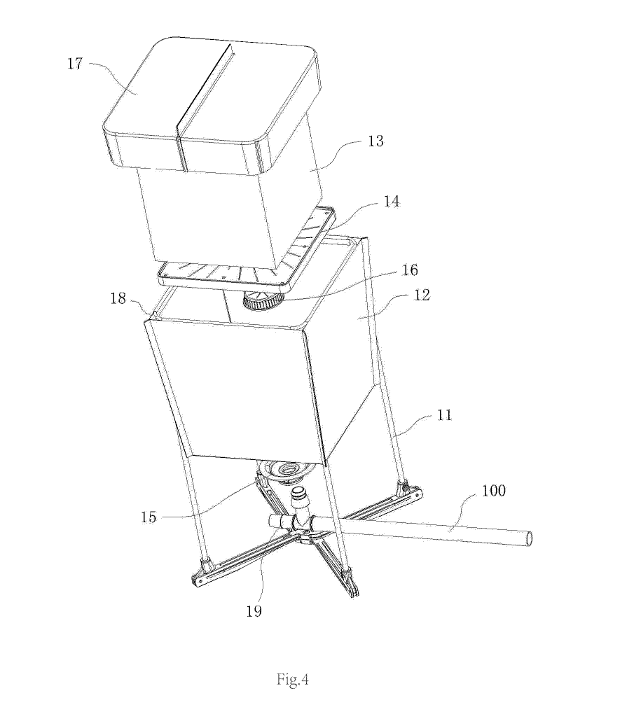

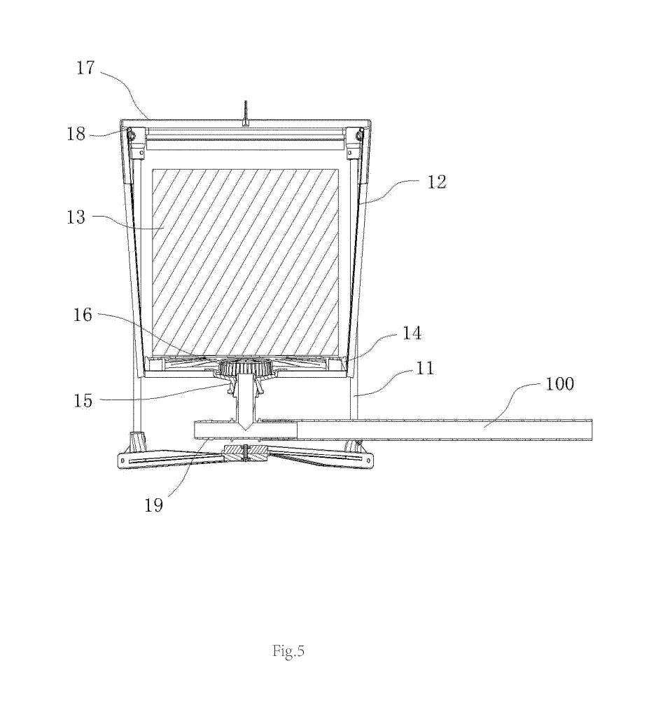

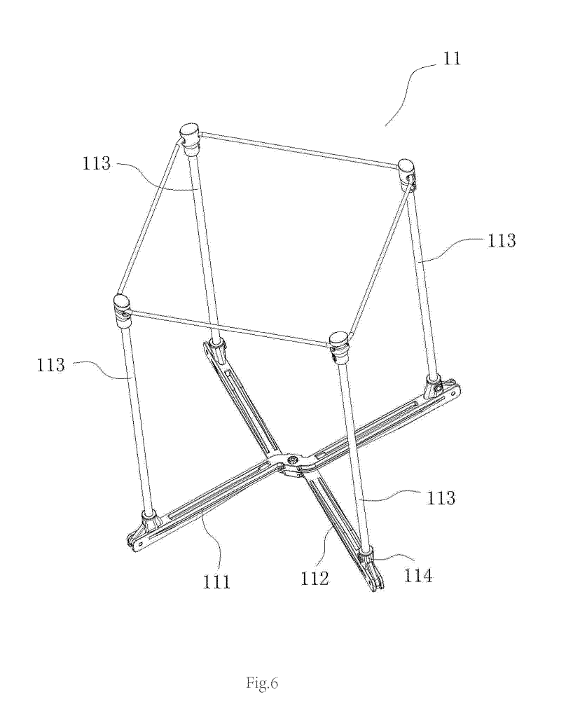

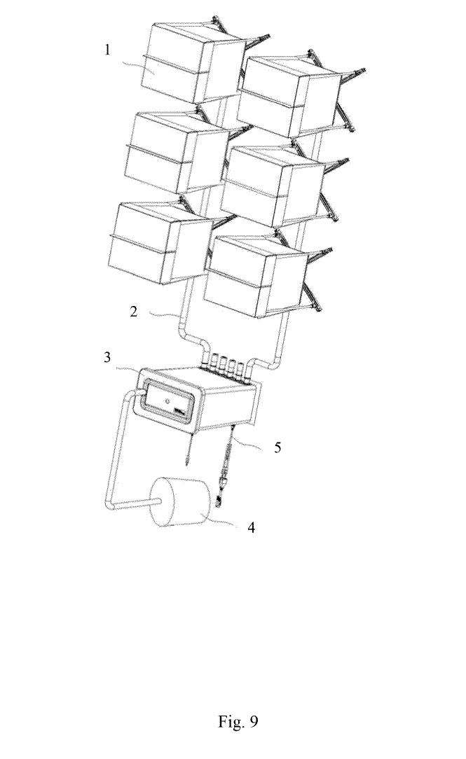

Example: please refer to the FIG. 3 to FIG. 9, the flexible hydroponics growing model 1, include its skeleton 11, growing container module 12 and growing medium 13.

Skeleton 11, its support framework for the whole growing system, the framework can be considered as a fold frame structure or detachable bracket, both kinds of structures can be opened or closed;

Growing Container module 12, made of flexible material, supported by skeleton 11, which can be filled with water as container of growing medium 13. The bottom of the container welds outlet 15 as flooding and draining conveying section for nutrient solution of hydroponic growing module. The growing container module 12 contains growing medium 13; The skeleton 11 can be folded or unfolded. The growing module is formed when the skeleton is unfolded and connects with the growing module made of flexible material, when the skeleton separates from the growing module made of flexible material and folds the skeleton, the size of growing module will be reduced significantly. Module as shown in FIG. 3 to FIG. 5, a supporting floor is installed inside the growing container module 12 and located under the growing medium 13, which can Separate the growing medium from the bottom of the container. The supporting floor 14 has holes or slots in it, the floor can be made of plastic or other materials. The outlet is welded in the bottom of the container, on which assembles root protector 16 allowing water to flow through. The root protector 16 can prevent water flow from blocking by the growing roots of plants. The root protector also acts as filter to block the larger particles in the nutrient solution. The outlet is connected by the pipe connecting part 19 to the main supply pipe 100. The container module is supported by the skeleton outside and provide it the vertical support. At the top of the growing container module 12 is open, on which is covered a flexible upper cover 17 used to seal and prevent light and insects in. The growing container module 12 is supported by the bending ring 18 at the top of it that keep the container a certain shape. The bending ring 18 is fixed in the buckle groove at the top of the support frame, together with vertical skeleton construct a rigid body to provide support for flexible cloth container. The bending ring 18 can be made by stainless steel/plastic ring or other metal ring.

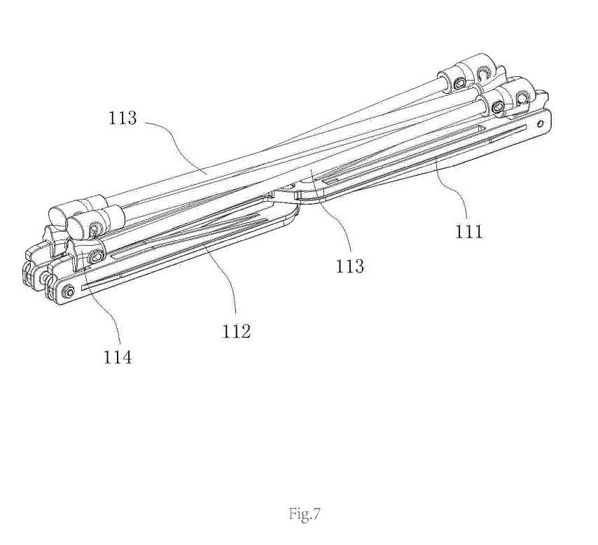

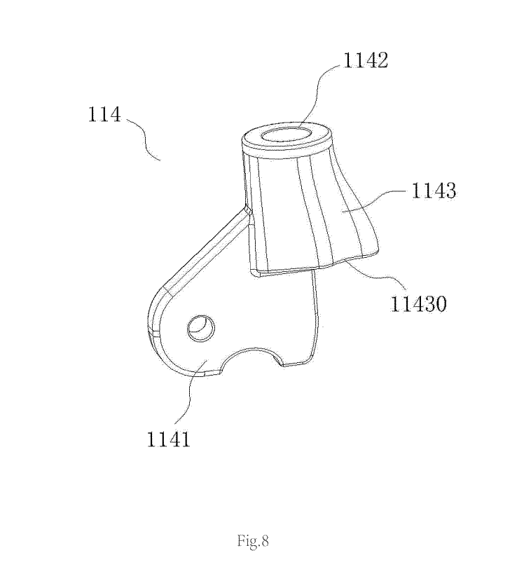

As shown in FIG. 6, FIG. 7 and FIG. 8, the invention adopts the skeleton 11 is folding frame. At the bottom of frame, a first piece of plate 111 and a second piece of plate 112 are connected with a shaft, make it rotatable. At both ends of the plate are connected respectively with shores 113 by rotary joint part 114, make it can be folding. When fold frame that can form skeleton to support the container model. There are u-shaped slots on both ends of plate 111, one end 1141 of rotary joint part 114 is connected in the u-shaped slot with shaft, it can turn up and down. Shores 113 is fixed on the other end 1142. The rotary joint part 114 have a locking connection part 1143, which cooperate together with the first piece of plate 111 and the second piece of plate 112 to hold up the frame vertically. Rotary joint part 114 can be turned down 270° and folded shores close parallel to the plate 111/112. The shores 113 are perpendicular to supporting surface 11430. The rotary joint part 114 and shores 113 can be connected with each other by inserting, welding or riveting.

The flexible material of the growing module can be waterproof cloth, flexible rubber, soft plastic or other soft material, said materials are waterproof material and the space can be ⅕ of the unfolded space when compressed. The hydroponics growing medium can be rock wool, coconut shell fibers, pebbles, bubble, and any other one or their combination. The shape of growing medium model is matched to the growing module.

A model of flexible hydroponic system includes the central distribution container 3, the main water storage container 4 and numbers of flexible hydroponic growing module 1. The flexible hydroponic growing module 1 is connected to the central distribution container 3 through pipelines 2; the central distribution container 3 connects with the main water storage container 4 filled with nutrient solution; the nutrient solution is pumped into or pumped out central distribution container 3 according to the preset program. Float switches 5 are installed in the central distribution container 3, and connected to the central controller by wires. The central controller automatically pumps out nutrient solution to the distribution container according to the program, the increasing nutrient solution will flow into the flexible hydroponic growth model by gravity and gradually fills it to preset level of height. The Float switches 5 are installed at the bottom and the top of the central distribution container. The main water storage container installs ‘flood pump’ on the bottom, the central distribution container installs the ‘drain pump’ at the bottom. The central controller automatically pumps out nutrient solution to the distribution container according to the program, and then it respectively flow into the growth model and gradually to preset level of height. When after all growth models filled with water, the drain pump will be activated to drain nutrient solution of growth models and the distribution container 3 to the main water storage container 4 by the controller program.

There are approximately 100 different hydroponic systems on the market, but all of them can be divided into just 4 groups.

1, Recirculating; 2, Run-to-waste; 3, Deep water culture; 4, Aeroponics.

Within each hydroponic system group are many various methods to apply each technique. Our flexible grow module design can be used with all of the methods except for Aeroponics, but is best suited to be used as a recirculating system. In a recirculating hydroponic system, the water is pumped from a storage tank out to the plants, and then recovered (re-circulated) back to the water storage tank. Our design will be best suited to be used as a flood-and-drain recirculating system.

The invention flexible hydroponic growing module design allows growers to use cheap, lightweight and foldable cloth material support and to accommodate the plants root system growth medium, at the same time, we also design the folding support frame, which will supports the growing module.

Our design avoid the current rigid solid wall of structure to use flexible waterproof cloth, and the ability of storing water is equal to the rigid solid wall of growth model/container.

A complete flexible hydroponic system, as shown in FIG. 8, The growing module is connected to the central distribution by 20 mm diameter flexible pipeline. the main water storage container full nutrient solution, nutrient solution is pumped into or out according to program, The flood pump is at the bottom of the main water storage container, The drain pump is at the bottom of the central distribution container, the two pump's outlets are connected together with 20 mm tubing. Float switches are installed at the bottom and the top of the central distribution container, connected to the central controller by wires. The central controller automatically pumps out the nutrient solution into the central distribution container according to program. And then it respectively flows into the growing module and gradually to preset level of height. When after all growing modules filled with water, the drain pump will be activated to drain nutrient solution of growing modules and the distribution container to the main water storage container by the controller program.

Our design is using the folding support frame as support framework of the growing system and the framework make the growing module firm and stable stand. The two plates locating at the bottom of folding frame are connected by a shaft in order to make it rotatable, Shores is connected to the plates at the end of it with rotary shaft that make it foldable. When open the skeleton and assemble with stainless steel ring on the top of it, flexible growing module is as stable as solid wall growing model, same as the one shown in FIG. 6, each of the flexible cloth growing module will use folding frame to stand vertically, and the forming stainless steel circle together with vertical folding bracket construct a rigid body to provide support for flexible cloth container. When fold close the skeleton, it will be folded into a bundle, as shown in FIG. 7.

Our design can use all general hydroponic growing medium in use today, including rock wool, coconut shell fibers, pebbles, foam and any other soilless growing mediums. Our design is best suitable for preformed rock wool or rock wool squares which have the advantage of sterile, easy to use, stable, and was widely used in the growth of their respective kinds of crops.

Our design consists of flexible waterproof cloth material, can be filled with water and used as containers of growing medium. The four angles of flexible cloth material are supported by the outer folding frame. The bending metal ring supports at the top of the flexible material to keep a certain shape and fixed on the supporting frame. Our design also incorporates the other unique features—the cover, which make the product prevent root eating insects enter, and inhibit the growth of the algae on the growing medium. The cover will be installed on the top of the individual growing model, used to seal and prevent light and insects into the growing medium. the growing medium (rock wool cube) is placed on the top of the plastic floor, make the growing medium separated from the bottom of flexible material. The container is made of flexible material (PVC coated cloth), at the bottom of it is the high frequency welds outlets used for flowing water or nutrient solution. A filter (also called as root protector) is Installed on the outlet act as filter to block water impurities and prevent the pipe get block, at the same time also have the effect of preventing the roots grow down into the main supply pipe so as to ensure the water can normally flow into or out growing model. Outlet connected with T shape fitting get through 20 mm diameter PVC main water pipe to the distribution container.

The side wall of the growth model/container can be made of flexible rubber cloth/material, this kind of flexible waterproof material can be compressed to only take up ⅕ space of the rigid standard container model.

The bottom of the flexible material container (PVC coated cloth) high frequency welds an outlet. The main water pipe is sealed connected to the outlet of the individual growing model through the plastic T shape fittings. At the same time on the bottom of the container is made of flexible material, a rigid plastic is placed above to prop up the plant roots gin rowing medium, and play the role of primary protection to prevent the roots of the plants from growing down into the main water pipe.

The supporting frameworks outside the model containers (flexible) is folding skeleton using plastic or rigid aluminum tube or pillars, it will support the plants and the growing medium, and make the individual growing module off the ground a certain height. The two plates locating at the bottom of folding frame are connected by a shaft in order to make it rotatable, Shores are connected to the plates at the end of it with shaft of rotary joint part to make them foldable. When open the skeleton and assemble with stainless steel ring on the top, flexible growing model is as stable as rigid solid wall growing model, When fold close the skeleton, it will be folded into a bundle.

Root protector or filter can prevent plastic outlet from blocking by the growing of plant roots. When the plants grow, their roots grow down filled the bottom of the growing module. if roots are allowed to grow directly, they will block in and out of the gate, so that it will have a significant impact on the flooding and draining system of individual growing module and the connected pipe. “Root protector” is designed to prevent the plant roots growing down into the water connection system, and can make the water flowing into or out of the growing module get smaller increasing resistance. “Root protector” also acts as filter to block the larger particles of the nutrient solution, prevents the large particles flowing into the main pipe and cause block.

We design a complete cover (also using the flexible materials), first it enables users to fix plants on the growing medium of container; Second User can fold in the upper portion of the growing module to protect them (using Velcro). Carries on the multiple effect, first of all, it prevents the light into the growing medium, prevent light into the roots, prevents the root destroying by the entering light. The cover prevents the growing of algae in the growing medium, also the cover can prevent roots eating by insects, fungus gnats and other insects can cause damage to the plants roots. The final purpose of the cover is to reduce evaporation by creating a vapor barrier between the wetted rooting area of the plants and the “above ground” area above the rooted area. Finally cover also has rainproof function, prevent rain water from entering the container and dilute nutrient solution.

The above record, only the implementation example of using this technology content, any person who are familiar with the craft of this item to make the modifications, changes, are included in this creation of patent scope, but not limited to implementation example reveals.

1. A flexible hydroponics growing model comprising:
a skeleton which can be fold or unfolded;
a growing module made of flexible material;
a growing medium;
wherein the skeleton supports the growing module as a framework;
wherein the growing medium is hold by the growing module;
wherein the growing module can be filled with water as container and water will be pumped in or out from the growing medium through an outlet located in the bottom of the growing module;
wherein the growing module is formed when the skeleton is unfolded and connects with the growing module made of flexible material;
wherein when the skeleton separates from the growing module made of flexible material and folds the skeleton, the size of growing module will be reduced significantly.

2. The flexible hydroponics growing model of claim 1, wherein in the growing module, there is a support floor located in the bottom of the growing medium which can separate the growing medium from the bottom of the growing module and there are a plurality of holes and slots in the support floor;
wherein there is a root protector installed on the outlet located in the bottom of the growing module which allows water flowing in and prevents the outlet to be blocked by well developed root, the root protector can also act as a filter which prevents larger particles of nutrient flowing into a pipe and cause blocking;
wherein at the outlet of the growing module, there are a plurality of pipe interconnecting pieces connected to a main water supply line.

3. The flexible hydroponics growing model of claim 2, wherein the growing module is supported by the skeleton which provides vertical support and the top of the growing module is designed with a flexible cover in order to seal and prevent light or insects.

4. The flexible hydroponics growing model of claim 3, wherein the growing module further comprises a bending ring which is fastened at the buckle groove on top of the skeleton and a rigid body is formed by the bending ring and the skeleton which provides support for the growing module;
wherein the top of the growing module is supported by the bending ring and is kept in certain shape.

5. The flexible hydroponics growing model of claim 1, wherein the skeleton can be folded and further comprises two pieces of plate locating at the bottom of the skeleton and connect with a shaft to make it rotatable; wherein both ends of the plate are respectively connected with shores and makes it foldable;
wherein when the skeleton is unfolded, the skeleton can support the growing module.

6. The flexible hydroponics growing model of claim 5, wherein the shores are connected to a u-shape slot in both ends of the plate with a rotary joint part;
wherein one side of the rotary joint is connected to u-shape slot of the plate with a shaft which can rotate up and down and the other side of the rotary joint part is constantly connected with the shores;
wherein when rotating the shores through the shaft connected with rotary joint part in an angle of 270°, the shores will be folded and are parallel to the plate.

7. The flexible hydroponics growing model of claim 6, wherein the extending line of the shores is perpendicular to the touching surface of the rotary joint part.

8. The flexible hydroponics growing model of claim 6, wherein the shores and the rotary joint part can be connected with each other by inserting, welding or riveting.

9. The flexible hydroponics growing model of claim 1, wherein the flexible material of the growing module can be waterproof cloth, flexible rubber, soft plastic or other soft material, said materials are waterproof material and the space can be ⅕ of the unfolded space when compressed.

10. The flexible hydroponics growing model of claim 9, wherein the flexible material is PVC coated cloth or laminated PVC sheet.

11. The flexible hydroponics growing model of claim 1, wherein the growing medium can be rock wool, coconut shell fibers, pebbles, and any one of the growing mediums that is soil-free or the combination of the growing mediums;
wherein the shape of the growing medium is matched to the growing module.

12. A flexible hydroponics growing system, comprising:
a plurality of flexible hydroponics growing models;
a plurality of pipelines;
a central distribution container;
a main water storage container;
a plurality of float switches;
a center controller;
wherein the flexible hydroponics growing model is connected to the central distribution container through the pipelines and the central distribution container is connected to the main water storage container;
wherein the float switches is installed inside the central distribution container and connected with the central controller;
wherein the main water storage container is filled with nutrient solution and the central controller automatically pumps out nutrient solution into the central distribution container;
wherein water respectively flows into the flexible hydroponics growing model and gradually to present level of height.

13. The flexible hydroponics growing system of claim 12, wherein the float switches are installed at the bottom ad the top of the central distribution container and are connected to the main controller through a connection cable.

14. The flexible hydroponics growing system of claim 12, wherein there is a flood pump installed at the bottom of the main container and a drain pump installed at the bottom of the central distribution container;
wherein when the flexible hydroponics growing model are filled with water, the drain pump will be activated and drains back the water into the main container according to settings on the controller.
